(19) United States
(12) Patent Application Publication
(10) Pub. No.: US 2014/0147090 A1
(43) Pub. Date: May 29, 2014

(54) IMAGE CAPTURING APPARATUS, IMAGE PROCESSING APPARATUS, AND CONTROL METHOD THEREFOR

(71) Applicant: CANON KABUSHIKI KAISHA, Tokyo (JP)

(72) Inventor: Kotaro Kitajima, Yokohama-shi (JP)

(21) Appl. No.: 14/088,943

(22) Filed: Nov. 25, 2013

(30) Foreign Application Priority Data
Nov. 29, 2012 (JP) 2012-261624

(51) Int. Cl. H04N 5/77

(52) U.S. Cl. CPC H04N 5/77
USPC 386/224

(57) ABSTRACT

An image capturing apparatus comprises: an image sensor that senses an image and outputs image data; a processing unit that performs image processing on the image data based on first processing information that is based on an instruction from a user; an obtainment unit that obtains comparison information based on a comparison between the first processing information and second processing information for putting the image data into a predetermined standard state through the image processing; and a recording unit that records the comparison information obtained by the obtainment unit in association with the image data.

### BACKGROUND OF THE INVENTION

1. Field of the Invention

The present invention relates to image capturing apparatuses, image processing apparatuses, and control, methods therefor, and particularly relates to image capturing apparatuses, image processing apparatuses, and control methods therefor for performing image processing such as color grading on an image during sensing of an image or after an image has been sensed and recorded.

2. Description of the Related Art

Conventionally, there are image capturing apparatuses such as digital cameras that capture images of subjects such as people and record those images as moving images. Meanwhile, in addition to cut editing, it has become common in production facilities such as digital cinema studios to apply color grading processes that adjust captured images to a desired appearance. This color grading process is carried out using color grading equipment in an editing studio or the like after image sensing and recording. Rough color grading is carried out during image sensing when on the set, and detailed color grading is only carried out after image sensing and recording. Carrying out color grading during image sensing makes it possible to reduce the processing load of the color grading carried out after image sensing and recording.

When carrying out color grading during image sensing, the digital camera records images and also outputs images to an external color grading apparatus through an HD-SDI cable or the like. The color grading apparatus applies the color grading process to the inputted images and records only color grading parameters (for example, see Japanese Patent Laid-Open No. 2009-21827). Through this, the effect of the color grading applied during image sensing can be reproduced in the color grading processing carried out after image sensing and recording by applying the processing to the captured images using the color grading parameters recorded during image sensing. As a result, the processing load of the color grading after image sensing and recording can be reduced, as mentioned above.

Meanwhile, it is often the case during image sensing that the images recorded by the digital camera are recorded in a format with the highest amount of information, such as raw data or the like, and images developed based on predetermined development parameters are then output to the external color grading apparatus. However, when the images output to the color grading apparatus differ from the images recorded by the camera, there have been cases where the results of the color grading process have differed even when applying the same color grading parameters used during image sensing in the color grading after image sensing and recording.

### SUMMARY OF THE INVENTION

The present invention has been made in consideration of the above situation, and enables details of a color grading process performed during image sensing to be reproduced in a color grading process after image sensing and recording even in the case where the state of an image recorded by a camera differs from the state of an image to undergo color grading.

According to the present invention, provided is an image capturing apparatus comprising: an image sensor that senses an image and outputs image data; a processing unit that performs image processing on the image data based on first processing information that is based on an instruction from a user; an obtainment unit that obtains comparison information based on a comparison between the first processing information and second processing information for putting the image data into a predetermined standard state through the image processing; and a recording unit that records the comparison information obtained by the obtainment unit in association with the image data.

Further, according to the present invention, provided is a control method for an image capturing apparatus including an image sensor that senses an image and outputs image data, the method comprising: a processing step of performing image processing on the image data based on first processing information that is based on an instruction from a user; an obtainment step of obtaining comparison information based on a comparison between the first processing information and second processing information for putting the image data into a predetermined standard state through the image processing; and a recording step of recording the comparison information obtained in the obtainment step in association with the image data.

Furthermore, according to the present invention, provided is an image processing apparatus comprising: an obtainment unit that obtains the image data and comparison information, wherein the comparison information is based on a comparison between first processing information for image processing to the image by an image capturing apparatus and second processing information for putting the image data into a predetermined standard state through the image processing; a first processing unit that performs the image processing on the image data obtained by the obtainment unit in order to put the image data into the standard state; and a second processing unit that performs image processing based on the comparison information on the image data processed by the first processing unit.

Further, according to the present invention, provided is a control method for an image processing apparatus, the method comprising: an obtainment step of obtaining the image data and comparison information, wherein the comparison information is based on a comparison between processing information for image processing to the image by an image capturing apparatus and processing information for putting the image data into a predetermined standard state through the image processing; a first processing step of performing the image processing on the image data obtained in the obtainment step in order to put the image data into the standard state; and a second processing step of performing image processing based on the comparison information on the image data processed in the first processing step.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve co explain the principles of the invention.

FIG. 1 is a diagram illustrating a configuration of an image processing system according to an embodiment of the present invention;

FIG. 2 is a block diagram illustrating a configuration of a digital camera according so an embodiment;

FIG. 3 is a block diagram illustrating a configuration of an image processing unit according to an embodiment;

FIG. 4 is a flowchart illustrating a process for generating color grading parameters according to a first embodiment;

FIG. 5 is a flowchart illustrating an image data recording process according to the first embodiment;

FIG. 6 is a diagram illustrating an example of a structure of an image file according to the first embodiment;

FIG. 7 is a block diagram illustrating a configuration of a color grading apparatus according to an embodiment;

FIG. 8 is a flowchart illustrating an LMT file setting process performed by a color grading apparatus according to the first embodiment;

FIG. 9 is a diagram illustrating an example of an LMT file according to the first embodiment;

FIG. 10 is a block diagram illustrating a configuration of an image processing unit in a color grading apparatus according to an embodiment of the present invention;

FIG. 11 is a flowchart illustrating an image data recording process according to a second embodiment;

FIG. 12 is a diagram illustrating an example of a structure of an image file according to the second embodiment; and

FIG. 13 is a flowchart illustrating an LMT file setting process performed by a color grading apparatus according to the second embodiment.

### DESCRIPTION OF THE EMBODIMENTS

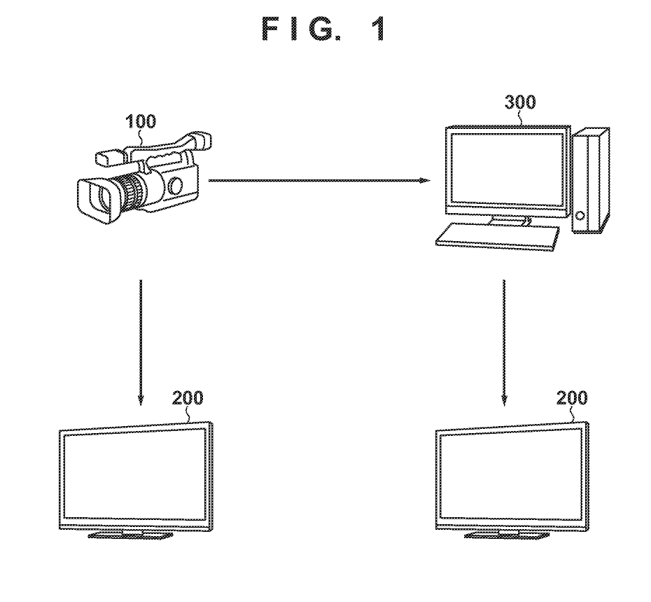

Exemplary embodiments of the present invention will be described in detail in accordance with the accompanying drawings. First, the configuration of an image capturing apparatus and image processing system embodying the present invention, which perform image processing equivalent to color grading using a camera during image sensing and record color grading parameters, will be described with reference to FIGS. 1 to 3.

Here, a case where the camera records images in the raw format, develops the images using given development parameters A, and outputs the developed images to the color grading apparatus during image sensing will be described as an example. During image sensing, the color grading apparatus applies a color grading process to the images developed using the development parameters A, and records the color grading parameters. Then, when performing the final color grading after image sensing and recording, the color grading apparatus receives data obtained by developing the captured raw data (or uses data developed by the color grading apparatus itself), and carries out processing in accordance with the recorded color grading parameters.

Thus in the case where the development parameters used by the color grading apparatus after image sensing and recording differ from the development parameters A used during image sensing, images that match the color grading results obtained during image sensing cannot be obtained even when processed with the same color grading parameters.

Although the foregoing describes a case where color grading is carried out externally from the camera during image sensing, it should be noted that the same problem occurs with processing equivalent to color grading executed within the camera as well.

### First Embodiment

FIG. 1 is a schematic diagram illustrating the configuration of an image processing system according to a first embodiment of the present invention. As shown in FIG. 1, the image processing system includes a digital camera 100 serving as an image capturing apparatus, monitors 200 that display images, and a color grading apparatus 300 that applies image processing such as color/luminance correction to images.

The camera 100 senses an image of a subject and records image data of the sensed image onto a recording medium, and also outputs sensed images to the monitor 200 during image sensing. After image sensing is complete, the color grading apparatus 300 loads the image data recorded onto the recording medium and performs a color grading processing on the loaded images. The color grading apparatus 300 also outputs images and the like resulting from the color grading to the monitor 200. Note that the monitor 200 connected to the camera 100 and the monitor 200 connected to the color grading apparatus 300 may be different monitors or may be the same monitor.

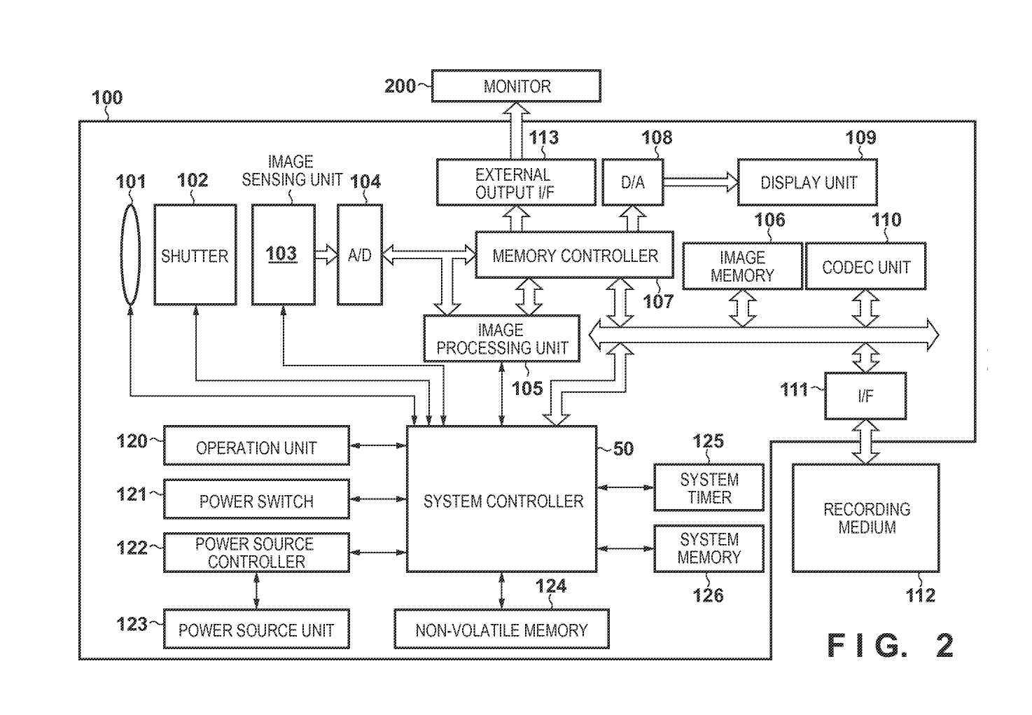

FIG. 2 is a block diagram illustrating the configuration of the digital camera 100. The flow of a basic process performed by the digital camera 100 when sensing an image of a subject will be described with reference to FIG. 2. An image sensing unit 103 is configured of a CCD sensor, a CMOS sensor, or the like that converts an optical image into an electrical signal; the image sensing unit 103 performs photoelectric conversion on light that enters through lens group 101, including a zoom lens and a focus lens, and a shutter 102, and outputs the result of the conversion to an A/D converter 104 as an input image signal. The A/D converter 104 converts an analog image signal output from the image sensing unit 103 into a digital image signal, and outputs the digital image signal to an image processing unit 105.

The image processing unit 105 performs various types of image processing, including color conversion processing such as white balance processing, γ processing, color correction processing, and so on, on the image data from the A/D converter 104 or image data read out from an image memory 106 via a memory controller 107. Note that details of the processing performed by the image processing unit 105 will be given later. Meanwhile, the image processing unit 105 performs predetermined computational processing using the sensed image data, and a system controller 50 performs exposure control and focus control based on results obtained from these computations. Through-the-lens (TTL) autofocus (AF) processing, autoexposure (AE) processing, and so on are carried out as a result. In addition, as the aforementioned white balance processing, the image processing unit 105 presumes a light source using the sensed image data through a process that will be described later, and carries out auto white balance (AWB) processing based on the presumed light source.

The image data output from the image processing unit 105 is written into the image memory 106 via the memory controller 107. The image memory 106 stores image data output from the image sensing unit 103, image data for display in a display unit 109, and the like.

A D/A converter 108 converts image data for display stored in the image memory 106 into an analog signal and supplies that analog signal to the display unit 109, and the display unit 109 carries out a display, in a display panel such as an LCD, based on the analog signal from the D/A converter 108. Meanwhile, the image data stored in the image memory 106 can also be output to the external monitor 200 via an external output interface (I/F) 113.

A codec unit 110 compresses and encodes the image data stored in the image memory 106 based on standards such as the MPEG standard. The system controller 50 stores the encoded image data or uncompressed image data in a recording medium 112, such as a memory card, a hard disk, or the like, via an interface (I/F) 111. Meanwhile, in the case where image data read out from the recording medium 112 is compressed, the codec unit 110 decodes the image data and stores the decoded image data in the image memory 106.

In addition to the aforementioned basic operations, the system controller 50 implements the various processes according to the first embodiment, mentioned later, by executing programs recorded in a non-volatile memory 124. The non-volatile memory 124 is a memory that can be recorded to and deleted electrically, and an EEPROM, for example, is used for the nonvolatile memory 124. Here, “programs” refers to programs for executing the various flowcharts according to the first embodiment, which will be described later. At this time, operational constants and variables of the system controller 50, programs read out from the nonvolatile memory 124, and the like are loaded into a system memory 126.

Meanwhile, as shown in FIG. 2, the camera 100 includes an operation unit 120 for inputting various types of operational instructions, a power switch 121, and a power source controller 122 that detects the status of a power source unit 123, such as whether or not a battery is mounted, the type of the battery, the power remaining in the battery, and so on. Furthermore, the camera 100 includes a system timer 125 that measures times used in various types of control, measures the time of an internal clock, and so on.

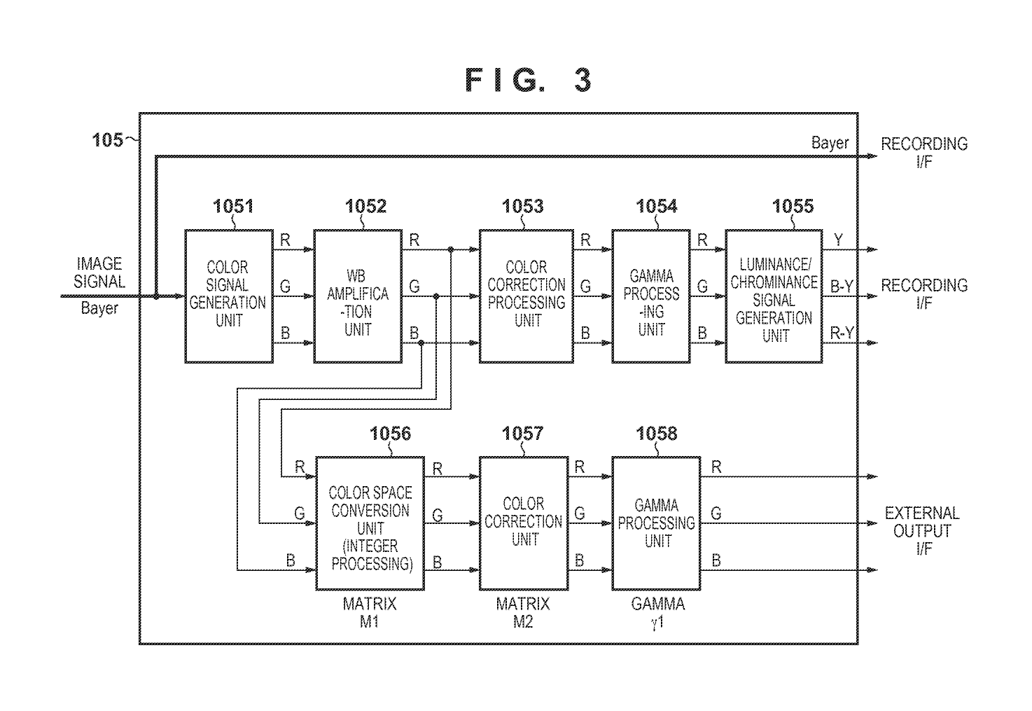

FIG. 3 is a block diagram illustrating the configuration of the image processing unit 105. Processing performed by the image processing unit 105 according to the present first embodiment, will be described with reference to FIG. 3. As shown in FIG. 3, an image signal from the A/D converter 104 shown in FIG. 2 is input into the image processing unit 105. The image signal input into the image processing unit 105 is input into a color signal generation unit 1051 as Bayer array RGB image data. In the case where an image is to be recorded directly in the Bayer RGB format (the raw format), the image signal input into the image processing unit 105 is output as-is. The output image signal can be recorded on the recording medium 112 via the I/F 111. The color signal generation unit 1051 generates R, G, and B color signals from the input Bayer array RGB image data, for all pixels. The color signal generation unit 1051 outputs the generated R, G, and B color signals to a WB amplification unit 1052.

Based on a white balance gain value calculated by the system controller 50, the WB amplification unit 1052 adjusts the white balance of the respective R, G, and B color signals by applying a gain thereto. A color correction processing unit 1053 corrects the color tones of the post-white balance processing R, G, and B color signals by carrying out 3×3 matrix processing, three-dimensional look-up table (LUT) processing, or the like thereon. Furthermore, a gamma processing unit 1054 carries out gamma correction such as applying gamma according to a specification such as Rec. 709, applying log-format gamma, or the like, and a luminance/chrominance signal generation unit 1055 generates a luminance signal Y and chrominance signals R-Y and B-Y from the color signals R, G, and B. The luminance/chrominance signal generation unit 1055 outputs the generated luminance signal Y and chrominance signals R-Y and B-Y to the I/F 111. The output luminance and chrominance signals can be recorded on the recording medium 112 via the I/F 111.

Meanwhile, the WB amplification unit 1052 also outputs the post-white balance processing R, G, and B color signals to a color space conversion unit 1056. The color space conversion unit 1056 converts the input B, G, and B color signals into RGB values of a predetermined standard. Although the present first embodiment assumes conversion into a color space according to the Academy Color Encode Specification (ACES) standard proposed by the Academy of Motion Picture Arts and Sciences (AMPAS), the present invention is not limited to this standard. Conversion to the ACES color space can be carried out by performing a 3×3 matrix computation (M1) on the R, G, and B color signals. However, although the ACES space is expressed using floating points, the processing here is performed using integer values obtained by, for example, multiplying the values by 1000. The color space conversion unit 1056 outputs the converted RGB values (ACES_RGB signals) to a color correction unit 1057. The color correction unit 1057 performs 3×3 matrix processing on the ACES_RGB signals. Here, the 3×3 matrix applied by the color correction unit 1057 is indicated by M2. This matrix M2 is determined through color granting processing carried out in response to user operations, as described later. Furthermore, a gamma processing unit 1058 carries out gamma conversion processing on the RGB signals in accordance with set gamma parameters γ1, and outputs the gamma-converted image signal to the monitor 200 via the external output I/F 113. Note that the properties of the gamma processing carried out here are determined through the color grading processing carried out in response to user operations, as described later.

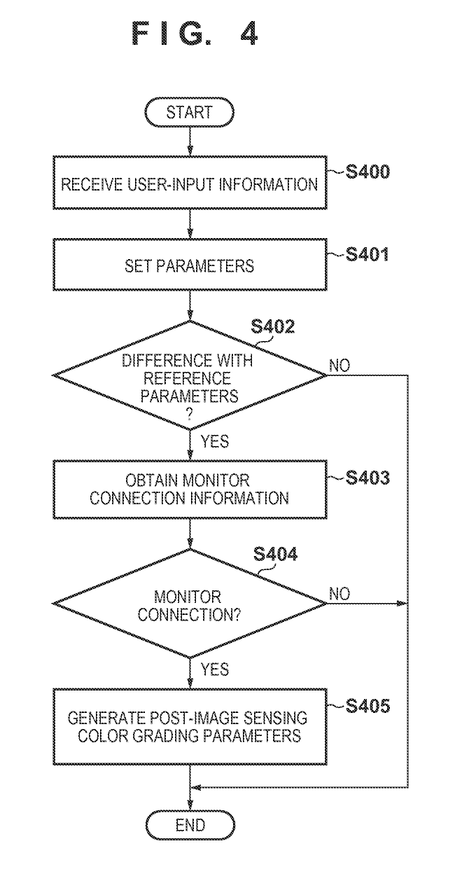

Next, processing performed by the system controller 50 when setting parameters for the image processing unit 105 prior to recording a sensed image will be described using the flowchart in FIG. 4. First, in step S400, operation input information made by a user through the operation unit 120 is received. The matrix M2 employed by the color correction unit 1057 and the parameters γ1 employed by the gamma processing unit 1058 are determined in accordance with the received information. The user then operates the operation unit 120 while viewing the image displayed in the monitor 200, setting the matrix M2 and the gamma γ1 so as to obtain a desired image quality. At this time, the operation unit 120 can accept the input of numerical values for the matrix M2 and the gamma γ1 directly, or can display pre-prepared matrices M2 and gammas γ1 and accept a selection thereof from the user.

In step S401, the parameters set through the user input are set in the respective processing units. Specifically, the matrix M2 parameters specified through the user input operations are set in the color correction unit 1057. Furthermore, the γ1 parameters specified through the user input operations are set in the gamma processing unit 1058.

In step S402, it is determined whether or not there is a difference between the matrix M2 and γ1 set in S401, and a matrix that serves as a reference. Specifically, it is determined whether the matrix M2 is different from a predetermined matrix M3 that serves as a reference (here, M3 is a matrix aligned with target values defined by ACES). Furthermore, with respect to gamma, γ1 is compared to a predetermined gamma γ2 that serves as a reference (here, γ2=0.45), and it is determined whether there is a difference between the two. In the case where there is a difference, the process advances to S403, whereas in the case where there is no difference, the process ends.

In step S403, connection information of the monitor 200 is obtained from the external output I/F 113, and in step S404, the monitor connection information obtained in step S403 is judged. In the case where there is a connection with the monitor 200, the process advances to step S405, whereas in the case where there is no connection, the process ends.

In step S405, color grading parameters used by the color grading apparatus 300 after image sensing and recording are generated. In this process, the color grading parameters are generated from the parameters set in the color correction unit 1057 and the gamma processing unit 1058. Specifically, comparison information between the reference parameters (the matrix M3 and γ2) and the user-specified parameters (the matrix M2 and γ1) is generated, and that comparison information is taken as the color grading parameters.

First, to describe the matrix, the matrix M2 specified by the user can be expressed through the following formula.

M2=M3×M4

This indicates that the matrix M2 set in the color correction unit 1057 is configured of the matrix M3 for converting into target values defined by ACES and a matrix Mi for converting from the ACES target values to the colors desired by the user. In this manner, the matrix M4 is generated from the matrix M2 specified through the user operations. In other words, the matrix M1 is obtained by applying the inverse matrix of M3, to M2.

Likewise, rather than the set gamma γ1, the gamma processing unit 1058 calculates a gamma γ3 indicating conversion from a linear state in which no gamma is applied to a state of post-gamma γ1 processing, and takes the γ3 parameters as the color grading parameters. Specifically, γ3 is obtained by applying the inverse of the reference gamma γ2 (for example, 0.45) to the gamma γ1 set by the user. The color grading parameters (M4 and γ3) are generated in this manner.

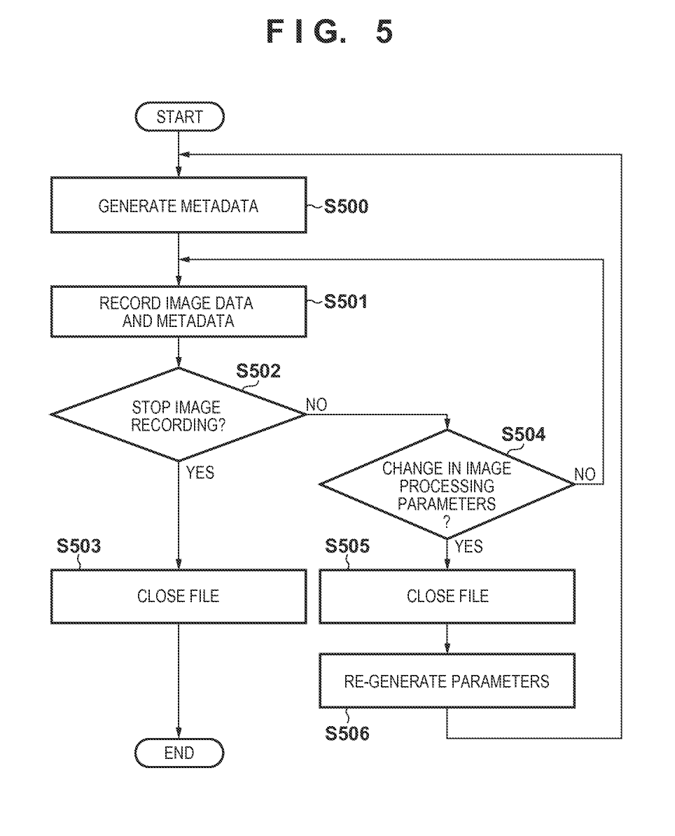

Next, a process performed by the camera 100 for recording the color grading parameters (M4 and γ3) generated based on user settings as described above in association with image data as metadata of a sensed image when sensing the image will be described. FIG. 5 illustrates the flow of a process performed by the system controller 50 when sensing an image.

When the user has made an operation through the operation unit 120 and instructed image recording to start, in step S500, metadata to be recorded along with the sensed image is generated. Here, the name of the manufacturer of the camera that is sensing the image, the date/time at which the image is sensed, the image size, and so on are generated as metadata. The color grading parameters generated through the process shown in FIG. 5 are also employed in the metadata.

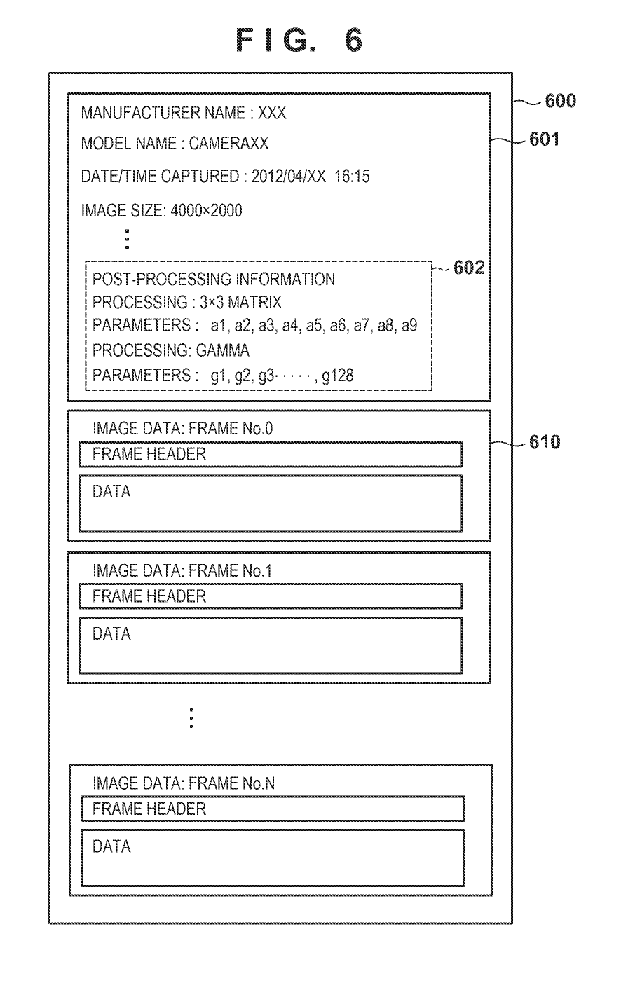

FIG. 6 illustrates an example of an image file that includes the metadata. FIG. 6 illustrates a file structure recorded by the camera 100. An image file 600 includes metadata 601 and frame-by-frame image data 610. As illustrated in FIG. 6, in the first embodiment, the metadata 601 is recorded in a header portion of the image file 600, and the metadata 601 contains color grading parameters 602.

In step S501, the image data is recorded on a recording medium. At this time, the image file 600, as illustrated in FIG. 6, is generated, and the metadata 601 is recorded in the header portion thereof. Following the header portion, the image data 610 of the sensed image is recorded on a frame-by-frame basis.

In step S502, it is determined whether or not the recording of the image has been instructed to stop based on information of an operation made by the user through the operation unit 120. In the case where the recording of the image has been instructed to be stopped, the process advances to step S503, where the file 600 currently being generated is closed and the recording of a single file on the recording medium 112 is ended.

On the other hand, in the case where the recording of the image has not been instructed to be stopped, the process advances to step S504, where it is determined whether or not the parameters (M2 and γ1) have been changed for the image processing unit 105 based on information of an operation made by the user through the operation unit 120. The process advances to step S505 in the case where there has been a change, and returns to step S501 in the case where there has been no change.

In step S505, the image file 600 currently being generated is closed and the recording of that file on the recording medium 112 as a single file is completed. In step S506, the color grading parameters are generated again. In other words, the same process as the process described in step S405 in FIG. 4 is carried out, and the color grading parameters (M4, γ3) are generated based on the matrix M2 and the gamma γ1 changed through the user operations. The process returns to S500 after the color grading parameters have been generated, whereupon a new image file 600 including the changed metadata 601 is generated.

By performing recording control as described above, a single image file is generated for a single instance of recording as long as no changes have been made to the color grading parameters. A new image file 600 is generated in the case where the color grading parameters have been changed. In other words, the color grading parameters are common for each image file 600.

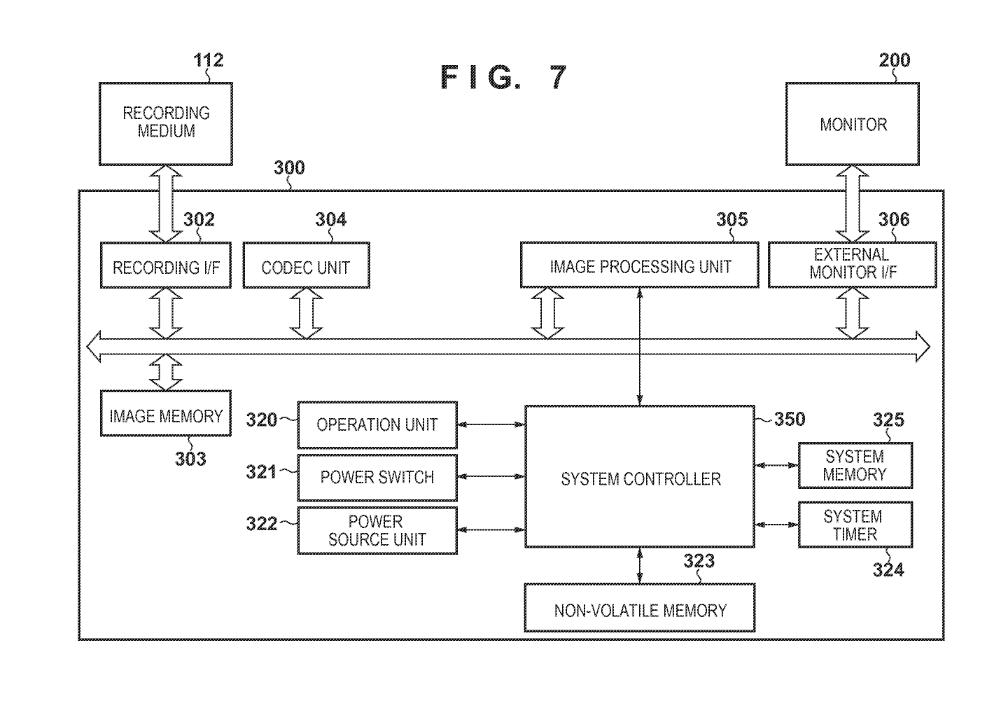

Next, a case will be described where the color grading apparatus 300 performs color grading processing, after image sensing and recording, on the image data recorded by the camera 100 through image sensing as described above. FIG. 7 is a block diagram illustrating the configuration of the color grading apparatus 300. First, the basic flow of image processing performed by the color grading apparatus 300 will be described with reference to FIG. 7. Here, a flow through which image data recorded into the recording medium 112 by the camera 100 is loaded and image processing is carried out will be described.

A system controller 350 accepts an image loaded from the recording medium 112 in response to the user operating an operation unit 320 configured of a mouse, a keyboard, a touch panel, or the like. In response to this, the image data recorded on the recording medium 112, which can be attached to/removed from the color grading apparatus 300 via a recording interface (I/F) 302, is loaded into an image memory 303. Meanwhile, in the case where the image data loaded from the recording medium 112 is encoded compressed image data, the system controller 350 passes the image data in the image memory 303 to a codec unit 304. The codec unit 304 decodes the encoded compressed image data and outputs the decoded image data to the image memory 303. The system controller 350 outputs the decoded image data, or uncompressed image data in the Bayer RGB format (raw format), that has been accumulated in the image memory 303 to an image processing unit 305.

The system controller 350 determines parameters to be used by the image processing unit 305 through a process mentioned later, and sets those parameters in the image processing unit 305. The image processing unit 305 carries out image processing in accordance with the set parameters and stores a result of the image processing in the image memory 303. Meanwhile, the system controller 350 reads out the post-image processing image from the image memory 303 and outputs that image to the monitor 200 via an external monitor interface (I/F) 306.

Note that as shown in FIG. 7, the color grading apparatus 300 also includes a power switch 321, a power source unit 322, a non-volatile memory 323 that can be recorded to and deleted electrically, and a system timer 324 that measures times used in various types of control, measures the time of an internal clock, and so on. Furthermore, the color grading apparatus 300 includes a system memory 325 into which operational constants and variables of the system controller 350, programs read out from the non-volatile memory 323, and the like are loaded.

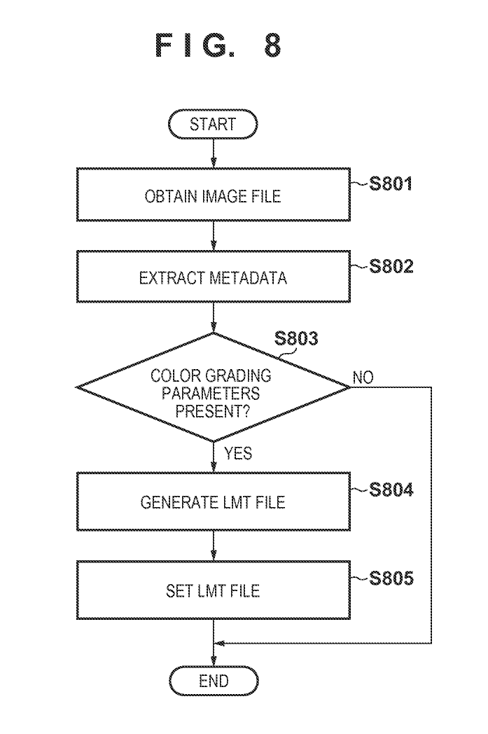

Next, the flow of a process performed in the first embodiment by the system controller 350 when determining the parameters for the image processing unit 305 will be described using the flowchart in FIG. 8. In step S801, the image file 600 read out from the recording medium 112 is written into the image memory 303, and in step S802, the metadata 601 recorded in the header of the image file 600 is extracted.

In step S803, the metadata 601 is analyzed, and it is determined whether or not the color grading parameters 602 (M1 and γ3) are recorded therein. In the case where the color grading parameters 602 are written in the header, the process advances to step S804, whereas in the case where the color grading parameters 602 are not written in the header, the process ends.

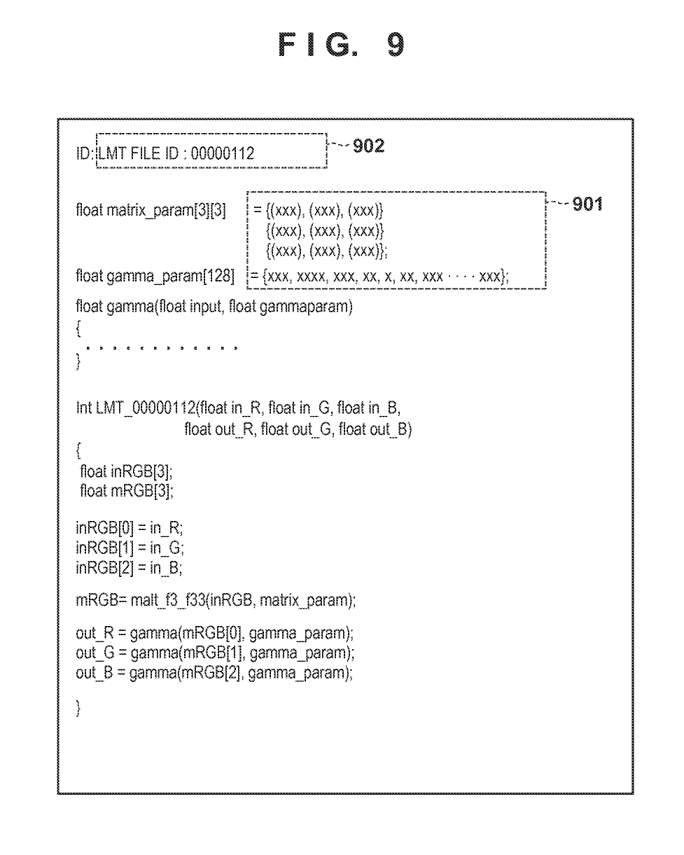

In step S804, a Look Modification Transform (LMT) file is generated in accordance with the color grading parameters 602. The LMT file is a file in which image processing details are written, and in the first embodiment, the LMT file is generated in the Color Transform Language (CTL) format, which is a description language proposed by the Academy of Motion Picture Arts and Sciences (AMPAS). An example of the generated LMT file is illustrated in FIG. 9. CTL is an interpreter language, and can apply image processing according to written instructions to an input image file.

Returning to FIG. 8, in step S805, the LMT file is set in the image processing unit 305. The image processing unit 305 executes the image processing written in the set LMT file, as described later.

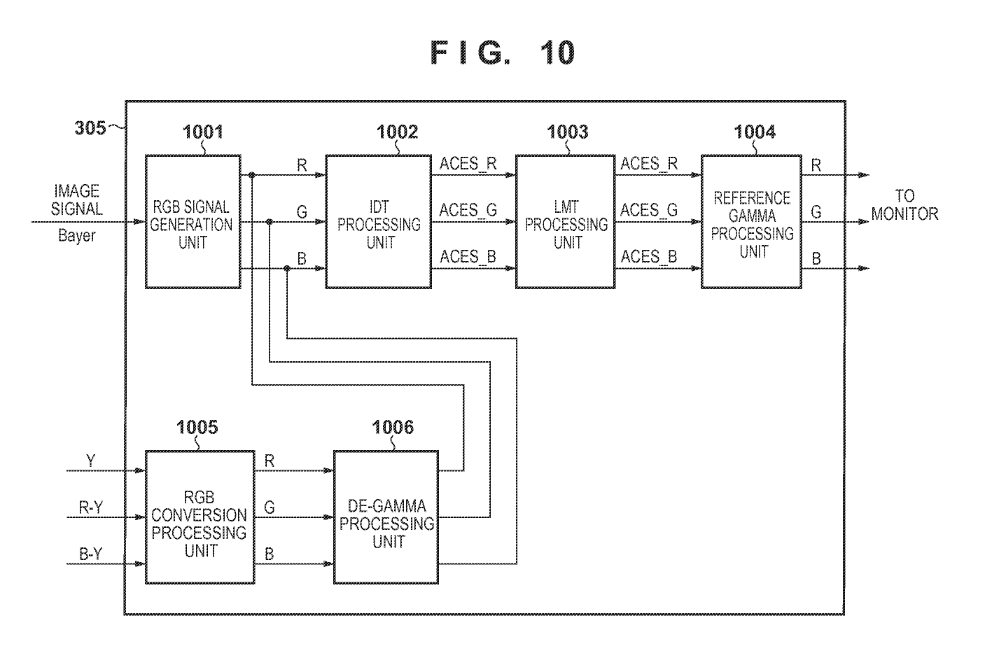

Next, processing carried out by the image processing unit 305 of the color grading apparatus 300 according to the first embodiment will be described. FIG. 10 is a block diagram illustrating the image processing unit 305 in detail. Here, a case where the image input into the image processing unit 305 is Bayer RGB format (raw format) image data will be described as an example.

As shown in FIG, 10, the Bayer RGB format (raw format) image data is input into an RGB signal generation unit 1001 under the control of the system controller 350. The RGB signal generation unit 1001 generates an RGB signal by de-Bayering the Bayer RGB format (raw format) image data. The generated RGB signal is then output to an Input Device Transform (IDT) processing unit 1002. The IDT processing unit 1002 performs two processes, namely a process for converting the input RGB signal into an ACES_RGB color space signal based on the ACES standard, and a process for correcting the ACES_RGB color space signal to color target values specified by the ACES standard. Here, the process for converting the RGB signal into an ACES_RGB color space signal based on the ACES standard is equivalent to the matrix calculation (M1) performed by the color space conversion unit 1056 shown in FIG. 3 and described above. However, while the matrix calculation M1 uses integer arithmetic, the calculation here uses floating points based on the ACES standard. Meanwhile, the process for correcting ACES_RGB color space signal to color target values specified by the ACES standard is equivalent to the matrix M3 that serves as a reference parameter. In other words, the IDT processing unit 1002 converts input RGB values into ACES-compliant RGB values by processing the matrices M1 and M3. The ACES_RGB data generated in this manner is output to an LMT processing unit 1003.

The LMT processing unit 1003 performs image processing in accordance with the set LMT file. In the case where an LMT file is not set, the image data is output without being processed. However, in the case where an LMT file is set, the LMT file is interpreted and processing is carried out in accordance with the details written therein. For example, in the case of the LMT file illustrated in FIG. 9, 3×3 matrix M4 processing and gamma γ3 processing are carried out. The LMT processing unit 1003 outputs the post-image processing ACES_RGB image data to a reference gamma processing unit 1001. The reference gamma processing unit 1004 applies gamma processing based on the standard of the monitor 200. For example, in the case where the monitor 200 is a Rec. 709-compliant monitor, gamma processing is performed, using the inverse of the monitor gamma (1/2.2 or 1/2.4), and the post-gamma processing RGB values are converted to integer values. The reference gamma processing unit 1004 then outputs the RGB values to the monitor 200 via the external monitor I/F 306.

As described above, in the first embodiment, the camera 100 generates the color grading parameters (matrix M4, gamma γ3) for a standard state (the ACES color space and color target values). The configuration is such that the generated color grading parameters are then recorded in association with the image data.

In addition, in the color grading apparatus 300, a loaded image is first converted by the IDT processing unit 1002 into the standard state (the ACES standard color space and color target values). Then, color grading parameter (M4, γ3) processing is carried out on the standard state. By passing on the color grading parameters with respect to the standard state in this manner, the color grading employed during image sensing can be reproduced after image sensing and recording, even in the case where the state of the recorded image differs from the state of the image during sensing.

Although the color space conversion unit 1056 and the color correction unit 1057 are described in the first embodiment as being different entities, as shown in FIG. 3, it should be noted than the actual matrix calculations may be carried out by a single circuit. In this case, the matrix set in the circuit is M1×M2, but as described earlier, M4 is generated and recorded in the metadata as the color grading matrix parameter.

In addition, although the first embodiment describes a case in which a 3×3 matrix and gamma properties are employed as the color grading parameters, other parameters may be used as well as long as they are image processing parameters. For example, the configuration may be such that a one-dimensional lookup table, a three-dimensional lookup table, or the like is employed as a parameter, a gain value, an offset value, or the like corresponding to RGB values are employed as parameters, and so on.

Furthermore, although the first embodiment describes a configuration in which the image output from the gamma processing unit 1058 is output to the monitor 200 when outputting an image from the camera 100 to the monitor 200, the present invention is not limited thereto. For example, RRT processing and ODT processing, as proposed by the Academy of Motion Picture Arts and Sciences (AMPAS), may be carried out in a stage after the gamma processing unit 1058, and the resulting data may be output. Here, Reference Rendering Transform (RRT) processing refers to processing for rendering a film tone image serving as a reference. Meanwhile, Output Device Transform (ODT) processing refers to processing for gamma and color space conversion based on an output device. In this case, the color grading apparatus 300 is configured to perform the RRT processing and the ODT processing instead of the processing performed by the reference gamma processing unit 1004 shown in FIG. 10.

In addition, although the first embodiment describes the ACES standard as an example of the standard state, any state aside from the ACES standard may be used as long as it is a state that converts according to a given standard state or generates color grading parameters. For example, the color grading parameters may be generated using, for example, the Adobe RGB color space so as to faithfully reproduce the colors of the subject, and those parameters may then be recorded in the metadata.

In addition, although the first embodiment describes a case in which the color grading apparatus 300 loads Bayer RGB format (raw format) image data as an example, the present invention can handle data recorded in other image formats as well. For example, a case in which luminance/chrominance data (Y, R-Y, B-Y), output from the luminance/chrominance signal generation unit 1055 of the camera 100 shown in FIG. 3, is taken as an input will be described with reference to FIG. 10. The luminance/chrominance data is input into an RGB conversion processing unit 1005 in the image processing unit 305 of the color grading apparatus 300. The luminance/chrominance data is converted to RGB data by the RGB conversion processing unit 1005, and is then outputted to a de-gamma processing unit 1006.

The de-gamma processing unit 1006 applies the inverse of the gamma processing applied by the gamma processing unit 1054 of the camera 100. The de-gamma processing unit 1006 outputs RGB data to the IDT processing unit 1002. The processing performed by the IDT processing unit 1002 is the same as described above, namely a process for conversion into the ACES color space and a process for conversion into ACES target values. Here, the process for conversion into ACES target values uses different values than the values used in the aforementioned case of Bayer RGB format (raw format) image data.

### Second Embodiment

Next, a second embodiment of the present invention will be described. The second embodiment describes a case where the LMT file is generated when recording an image. Note that the system configuration and the configurations of the various units in the second embodiment are the same as those described with reference to FIGS. 1, 2, 3, 7, and 10 in the first embodiment, and thus descriptions thereof will be omitted here. Furthermore, the generation of color grading parameters based on parameters set prior to the start of image sensing, as shown in FIG. 4, is the same as the process described with reference to FIG. 4 in the first embodiment.

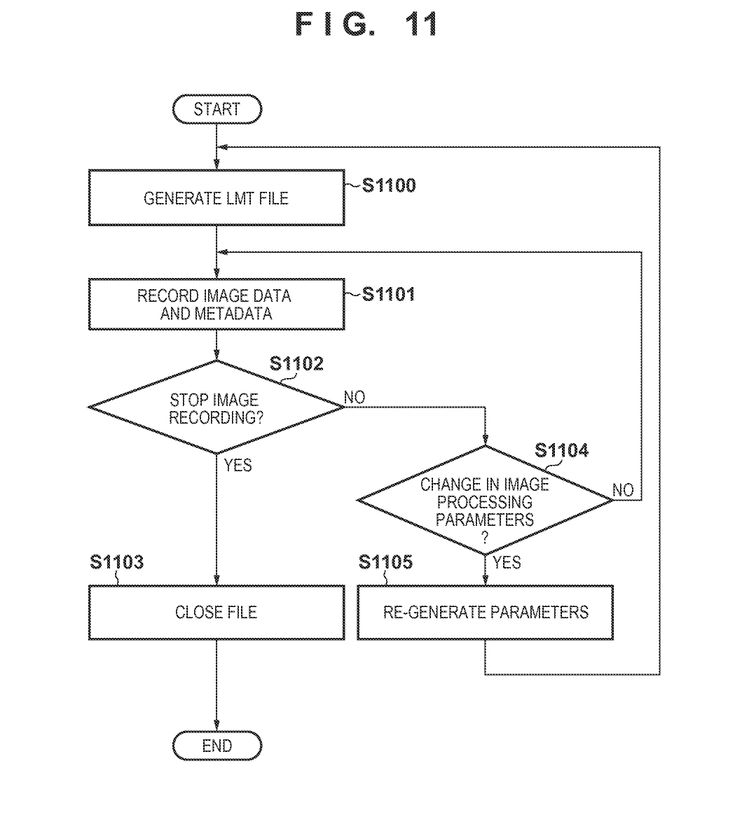

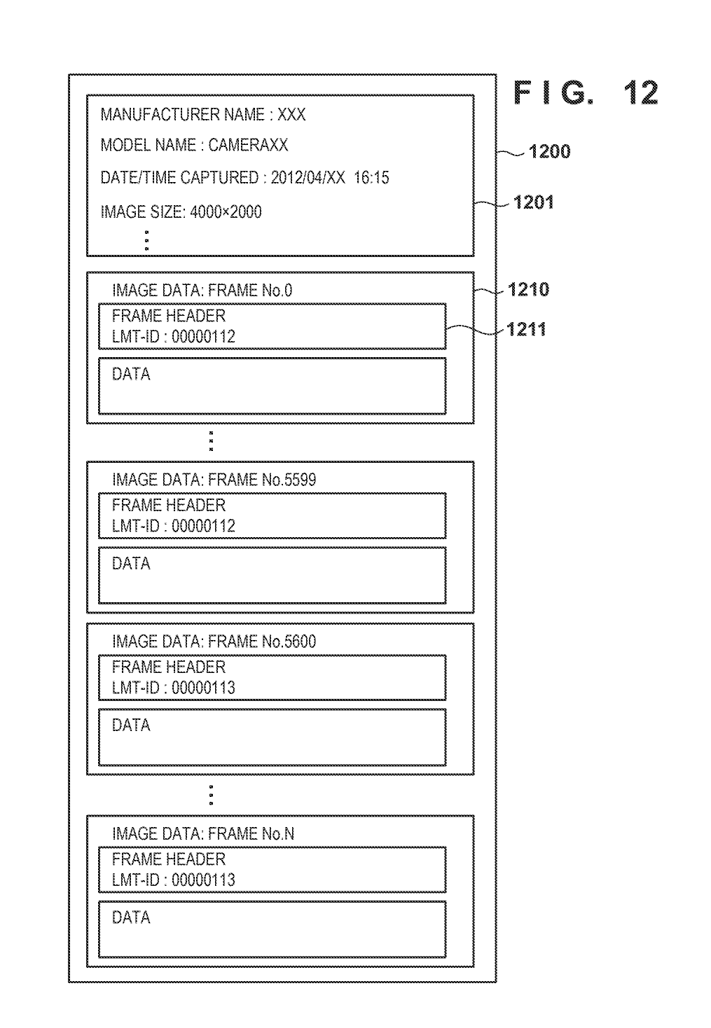

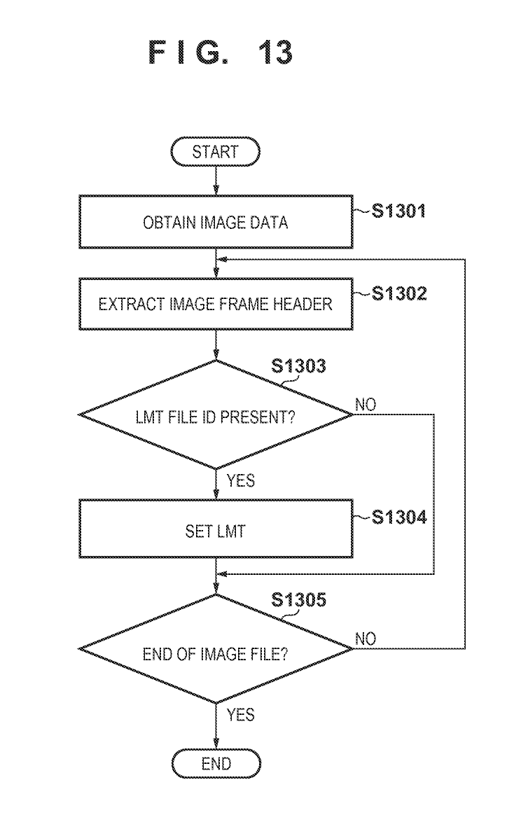

The second embodiment differs from the first embodiment in terms of the operations performed by the system controller 50 of the camera 100 when recording a sensed image and the processing performed by the color grading apparatus 300. Specifically, the camera 100 carries out processing indicated in the flowchart of FIG. 11 instead of the processing described with reference to FIG. 5 in the first embodiment, and an image file indicated in FIG. 12 is recorded instead of the image file indicated in FIG. 6. Furthermore, the color grading apparatus 300 performs processing indicated in FIG. 13 instead of the processing indicated in FIG. 8. Accordingly, the following descriptions will focus on these differences.

In step S1100, the LMT file is generated. Here, a file written in the LMT file format shown in FIG. 9 is generated based on the generated color grading parameters (M4, γ3). In this case, an LMT file template is held in advance, and only a parameter portion thereof (901 in FIG. 9) is overwritten. Furthermore, the unique ID (902 in FIG. 9) is assigned to the generated LMT file.

Here, FIG. 12 illustrates an example of an image file that includes the LMT file ID. As shown in FIG. 12, an image file 1200 includes a file header 1201 and frame-by-frame image data 1210; meanwhile, each frame of image data 1210 includes a frame header 1211 in which the generated LMT file ID is added as metadata. FIG. 12 illustrates an example in which an LMT file having an ID of 00000112 has been associated with frames No. 0 to No. 5599.

In step S1101, the image data is recorded on the recording medium 112 via the I/F 111. At this time, the image file 1200 as shown in FIG. 12 is generated, and when each frame of the image data 1210 is recorded, the ID of the generated LMT file is added to the frame header 1211 thereof as metadata.

In step S1102, it is determined whether or not the recording of images has been instructed to stop based on information of an operation made by the user through the operation unit 120. In the case where the recording of images has been instructed to be stopped, the process advances to step S1103, where the file 1200 currently being generated is closed and the recording of a single file on the recording medium 112 is ended.

On the other hand, in the case where the recording of the image has not been instructed to be stopped, the process advances to step S1104, where it is determined whether or not the parameters have been changed for the image processing unit 105 based on information of an operation made by the user through the operation unit 120. In the case where there has been a change, the process advances to step S1105, whereas in the case where there has not been a change, the process returns to step S1101, where the process for recording the next frame of the image data is carried out.

In step S1105, the color grading parameters are generated again. Here, the same process as the process of step S405 in FIG. 4, described in the first embodiment, is carried out. In other words, the color grading parameters are generated from the image processing parameters set in the image processing unit 105. After the color grading parameters have been generated, the process returns to step S1100, where the LMT file is generated based on the changed color grading parameters. A new ID is then assigned to the newly-generated LMT file.

FIG. 12 illustrates an example in which the color grading parameters have been changed starting with an image frame No. 5600. In this example, an LMT file having an ID of 00000113 has been associated with image frames No. 5600 to No. N.

Next, descriptions will be given of a flow of processing performed in the second embodiment when determining parameters for the image processing unit 305 in the case where the color grading apparatus 300 performs color grading processing, after image sensing and recording, on the image data recorded by the camera 100 through image sensing as described above. The processing indicated in the flowchart in FIG. 13 is carried out here, and the processing indicated in FIG. 13 is carried out instead of the processing described in the first embodiment with reference to FIG. 8.

In step S1301, one frame's worth of the image data 1210 contained in the image file 1200 is written into the image memory 303 from the recording medium 112, and in step S1302, the frame header 1211 of the image data 1210 is extracted.

In step S1303, it is determined whether the LMT file ID is written in the frame header 1211. In the case where the LMT file ID is written in the header, the process advances to step S1304, whereas in the case where the ID is not written in the header, the process advances to step S1305. In step S1304, the LMT file corresponding to the LMT ID written in the header is loaded, and the loaded TNT file is set in the image processing unit 305.

In step S1305, it is determined whether or not the image file ends with the image data 1210 currently being processed. In the case where the file ends, the processing also ends. On the other hand, in the case where the file does not end, the next frame of the image data 1210 is loaded, and the processing from step S1302 on is carried out on the new image data 1210.

Note that the processing carried out by the image processing unit 305 in accordance with the set LMT file is the same as that described above in the first embodiment, and thus descriptions thereof will be omitted.

As described above, according to the second embodiment, a configuration in which the LMT file is generated by the camera 100 and information specifying that LMT file is recorded in the image data is employed. As a result, it is not necessary for the color grading apparatus to generate the LMT file, and thus color grading apparatuses that cannot generate LMT files can easily reproduce color grading set during image sensing. In addition, by generating the LMT file, it is possible to specify not only the color grading processing details and processing parameters, but also the processing order.

Although the present second embodiment employs a configuration in which ID information of the generated LMT file is written in all of the frame headers, it should be noted that any method may be employed as long as the image data and the LMT file are associated with each other. For example, a configuration in which the generated LMT file is embedded in the file header may be employed as well. Here, in the case where there are a plurality LMT files, the plurality of LMT files are embedded in the file header. Embedding the LMT file in the image file header in this manner makes it possible to reduce occurrences of the user losing the LMT file and being unable to reproduce the color grading set during image sensing.

### Other Embodiments

Although the aforementioned first embodiment describes as an example a case in which the color grading parameters are recorded as metadata of the sensed image, the color grading parameters may be recorded in any format as long as they are associated with the sensed image. For example, the color grading parameters may be generated by the camera 100 as an LMT file, and link information linking to the LMT file may be recorded as metadata of the image file.

Specifically, a method in which a unique ID number is assigned when the LMT file is generated and that ID number is then recorded as the metadata of the sensed image can be employed. Alternatively, the configuration may be such that the camera 100 sends the LMT file to an external server via a communication unit (not shown), and URL information or the like of the destination server is recorded as the metadata of the recorded image. Furthermore, the LMT file itself may be recorded in the image file as the metadata.

In addition, although the aforementioned second embodiment describes a configuration in which the ID information of the generated LMT file is written into all of the frame headers, the color grading parameters may be recorded in all of the frame headers. In this case, the color grading apparatus may read out the color grading parameters contained in the frame headers of each frame of the image data, and may then generate the LMT file based thereon in the manner described in the first embodiment.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided so the computer for example via a network or from a recording medium of various types serving as the memory device (e.g., computer-readable medium).

While the present invention has been described, with reference to exemplary embodiments, it is to be understood than the invention is not limited to the disclosed exemplary embodiments. The scope of the following claims is so be accorded the broadest interpretation so as to encompass all such modifications and equivalent structures and functions.

This application claims the benefit of Japanese Patent Application No 2012-261624, filed on Nov. 29, 2012 which is hereby incorporated by reference herein in its entirety.

What is claimed is:

1. An image capturing apparatus comprising:
an image sensor that senses an image and outputs image data;
a processing unit that performs image processing on the image data based on first processing information that is based on an instruction from a user;
an obtainment unit that obtains comparison information based on a comparison between the first processing information and second processing information for putting the image data into a predetermined standard state through the image processing; and
a recording unit that records the comparison information obtained by the obtainment unit in association with the image data.

2. The image capturing apparatus according to claim 1, wherein the recording unit performs the recording during sensing of an image by the image sensor.

3. The image capturing apparatus according to claim 1 further comprising an output unit that outputs image data processed by the processing unit based on the first processing information to a display device.

4. The image capturing apparatus according to claim 1, wherein in the case where a plurality of images are processed by the processing unit using the same first processing information, the recording unit records a single piece of comparison information for image data of the plurality of images.

5. The image capturing apparatus according to claim 1, wherein the recording unit records image data, obtained by the processing unit performing image processing based on the second processing information on the image data, in association with the comparison. information.

6. The image capturing apparatus according to claim 1, wherein the recording unit does not record the comparison information in the case where the obtainment unit has not obtained the comparison information.

7. The image capturing apparatus according to claim 1, wherein the comparison information is third processing information expressing contents of image processing.

8. The image capturing apparatus according to claim 7, wherein the recording unit records a single piece of the third processing information for each individual image in the image data.

9. The image capturing apparatus according to claim 7, wherein the recording unit records link information for linking to the third processing information in association with the image data.

10. The image capturing apparatus according to claim 7, wherein the third processing information further indicates an order of the image processing.

11. The image capturing apparatus according to claim 1, wherein the first processing information and the second processing information include matrix for image processing.

12. The image capturing apparatus according to claim 1, wherein the first processing information and the second processing information include gamma value for gamma processing.

13. The image capturing apparatus according to claim 1, wherein the comparison information is a ratio of the first processing information and the second processing information.

14. The image capturing apparatus according to claim 1, wherein the predetermined standard state through the image processing is based on ACES standard.

15. The image capturing apparatus according to claim 7, wherein the third information is look modification transform file.

16. The image capturing apparatus according to claim 7, wherein the third information is generated complying with color transform language format.

17. A control method for an image capturing apparatus including an image sensor that senses an image and outputs image data the method comprising:
a processing step of performing image processing on the image data based on first processing information that is based on an instruction from a user;
an obtainment step of obtaining comparison information based on a comparison between the first processing information and second processing information for putting the image data into a predetermined standard state through the image processing; and
a recording step of recording the comparison information obtained in the obtainment step in association with the image data.

18. An image processing apparatus comprising:
an obtainment unit that obtains the image data and comparison information, wherein the comparison information is based on a comparison between first processing information for image processing no the image by an image capturing apparatus and second processing information for putting the image data into a predetermined standard state through the image processing;
a first processing unit that performs the image processing on the image data obtained by the obtainment unit in order to put the image data into the standard state; and
a second processing unit that performs image processing based on the comparison information on the image data processed by the first processing unit.

19. A control method for an image processing apparatus, the method comprising:
an obtainment step of obtaining the image data and comparison information, wherein the comparison information is based on a comparison between processing information for image processing to the image by an image capturing apparatus and processing information for putting the image data into a predetermined standard state through the image processing;
a first processing step of performing the image processing on the image data obtained in the obtainment step in order to put the image data into the standard state; and
a second processing step of performing image processing based on the comparison information on the image data processed in the first processing step.

20. A non-transitory readable storage medium having stored thereon a program which is executable by an image processing apparatus, the program haying a program code for realizing the image processing method according to claim 19.
